(19) United States
(12) Patent Application Publication
(10) Pub. No.: US 2012/0209658 A1
(43) Pub. Date: Aug. 16, 2012

(54) POPULATION MOBILITY ESTIMATION SYSTEM, POPULATION MOBILITY ESTIMATION METHOD, AND POPULATION MOBILITY ESTIMATION PROGRAM

(76) Inventors: Kazuhisa Shibayama, Tokyo (JP); Hirofusa Watamori, Tokyo (JP); Kazutaka Nagashima, Tokyo (JP); Toshiaki Senba, Tokyo (JP); Daisuke Miyaji, Tokyo (JP); Koji Kashimura, Tokyo (JP); Hirokazu Miyazaki, Tokyo (JP); Kohei Matsuda, Tokyo (JP)

(21) Appl. No.: 13/392,019

(22) PCT Filed: Jul. 21, 2010
(86) PCT No.: PCT/JP2010/004658

§ 371 Date: Apr. 26, 2012

(30) Foreign Application Priority Data
Aug. 24, 2009 (JP) 2009-193275

(51) Int. Cl. G06Q 30/02

(52) U.S. Cl. 705/7.29

(57) ABSTRACT

A system includes a calculation master storage unit to store a calculation master that is required for estimating the number of visitors to steady mobility facilities within a predetermined period of time, and is obtained by further classifying the steady mobility facilities by type, and a calculation master that is required for estimating the number of visitors to variable mobility facilities within a predetermined period of time, and is based on an actual survey value for each type obtained by further classifying the variable mobility facilities by type, and a building visitor number calculation unit to extract a name of a facility from map information, estimate a type of the facility based on the name, and refer to the calculation master corresponding to the type from the calculation master storage unit based on the estimated type, to calculate an estimate value of the number of visitors to the facility.

### TECHNICAL FIELD

The present invention relates to a population mobility estimation system, a population mobility estimation method, and a population mobility estimation program that are for estimating population mobility.

### BACKGROUND ART

Statistical population data in “population census” that is surveyed and released every five years by the Statistics Bureau of the Ministry of Internal Affairs and Communications encompasses all of Japan and is not only used for planning and implementing various measures in the national government and local governments but also widely used in various fields such as an academic field, educations, and a private sector. The population census is statistical data that represents static population in which inhabitant population (nighttime) and employee and student population (daytime) are aggregated.

A telecommunication carrier that provides communication services for a mobile phone and the like prepares an infrastructure such as a wireless base station so as to cover a communication traffic at a level close to the maximum value, for a region in which the communication traffic fluctuates depending on a time zone, a day of the week, and the like.

Meanwhile, an area including customer-attracting facilities such as an event site and a tourist spot has particularities in which, even if inhabitant (permanent) population is small, population temporarily flows in at a time when an event takes place, in a sightseeing season, and the like, and a communication traffic rapidly rises. For example, in tourist spots such as a prominent cherry blossom viewing spot and a spot in which a famous festival takes place, the number of telephone calls by mobile phones increases 2 to 4 times in sightseeing seasons as compared to seasons other than the sightseeing seasons.

Preparation of the infrastructure described above on the assumption of such peak seasons causes poor investment efficiency when other off-seasons are taken into consideration. Therefore, a telecommunication carrier takes measures to adjust a direction of an antenna of a base station or arrange a temporary base station or repeater apparatus (wireless relay apparatus) when an event occurs.

In addition, as disclosed in Patent Documents 1 and 2 below, separately from the statistical data such as population census, estimation of population within an area based on the number of mobile stations (communication terminals such as mobile phones) that have communicated with wireless base stations is also proposed.

In Patent Document 1, values obtained by counting, for each hour or area, position registration information issued from a terminal are statistically analyzed to perform short-term future prediction of a population distribution (claim 1, paragraph [0005], and the like).

Further, in Patent Document 2, based on an ownership percentage (share) of a mobile station in a specific area, the number of mobile stations whose positions are registered in wireless base stations, the number of mobile stations each having a wireless base station as a main communication destination, and the like, population residing in the area is estimated (claims 1 and 4 to 7, paragraphs [0018] and [0022], and the like).

### PRIOR ART DOCUMENTS

### Patent Documents

Patent Document 1: Japanese Patent Application Laid-open No. 2002-342557
Patent Document 2: Japanese Patent Application Laid-open No. 2002-354517

### DISCLOSURE OF THE INVENTION

### Problems to be Solved by the Invention

In the above-mentioned method of Patent Document 1, however, since attributes and the like of measurement areas such as tourist spots, residential districts, customer-attracting facilities, and business districts are not taken into consideration at all, an estimate value largely varies between at a time when an event takes place and at ordinary times, for example.

Since the method of Patent Document 2 has an object to grasp (provide) a congestion situation of customer-attracting facilities such as a theme park, an importance is placed on real-time performance, and the accuracy or convenience of statistical data is not taken into consideration. In other words, in this Patent Document 2, attributes and the like of customer-attracting facilities or areas are not taken into consideration at all, and how many people there are at present is merely estimated. Therefore, even if such data is accumulated, a rough congestion situation for each time zone or day of the week can be merely estimated, and such data cannot be set to be an index for designing station establishment by the telecommunication carrier, and the like.

In view of the problems described above, it is an object of the present invention to provide a population mobility estimation system, a population mobility estimation method, and a population mobility estimation program that are capable of estimating population mobility with high accuracy.

### Means for Solving the Problems

To achieve the above-mentioned object, according to an embodiment of the present invention, there is provided a system including a calculation basic information storage unit and an arithmetic means.

The calculation basic information storage unit stores first calculation basic information that is required for estimating the number of visitors to steady mobility facilities within a predetermined period of time, the steady mobility facilities serving as facilities where specific people come in and out routinely, and is obtained by further classifying the steady mobility facilities by type, and second calculation basic information that is required for estimating the number of visitors to variable mobility facilities within a predetermined period of time, the variable mobility facilities serving as facilities where unspecified people come in and out in a fluid manner, and is based on an actual survey value for each type obtained by further classifying the variable mobility facilities by type.

The arithmetic means extracts detailed information including at least a name of one of the facilities from map information, estimates a type of the facility based on the extracted name of the facility, and refers to the first calculation basic information or the second calculation basic information that corresponds to the type from the calculation basic information storage unit based on the estimated type, to calculate an estimate value of the number of visitors to the facility within a predetermined period of time. Further, the arithmetic means combines estimate values of the number of visitors for each of time zones sectioning the predetermined period of time in a predetermined regional unit, the estimate values being calculated for each of the facilities, to calculate population mobility estimation data.

While the population mobility of the number of visitors to steady mobility facilities is static, the population mobility of the number of visitors to variable mobility facilities is dynamic and varies depending on more detailed types of the variable mobility facilities. In the system according to the present invention, by calculating an estimate value of the number of visitors within a predetermined period of time based on the second calculation basic information defined based on an actual survey value for each type of facility that belongs to the variable mobility facilities, the arithmetic means can calculate, with excellent accuracy, an estimate value of the number of visitors within a predetermined period of time for each type of facility that belongs to the variable mobility facilities.

The system according to the present invention may further include a variation pattern information storage unit to store variation pattern information for each type indicating a temporal variation tendency of the number of visitors, for each of the types of the steady mobility facilities and the variable mobility facilities, and the arithmetic means may calculate an estimate value of the number of visitors within a predetermined period of time, the estimate value being calculated for the facility, and an estimate value of the number of visitors for each of time zones sectioning the predetermined period of time based on variation pattern information of the facility that is stored in the variation pattern information storage unit. Accordingly, for each of the types of the steady mobility facilities and the variable mobility facilities, population mobility for each time zone can be estimated.

In the system according to the present invention, the first calculation basic information and the second calculation basic information may include a coefficient for performing correction corresponding to an area on a calculation result of the estimate values of the number of visitors within the predetermined period of time. Accordingly, an estimate value of the number of visitors in which regional population or a population density is taken into consideration is obtained.

In the system according to the present invention, as the second calculation basic information of at least a part of types of facilities that belong to the variable mobility facilities, a calculation expression defined by a correlation between an actual survey value of a real number of visitors and the number of cars in a parking lot, a predetermined value based on an actual survey value of the number of visitors within a predetermined period of time, a calculation expression defined by a correlation between an actual survey value of a real number of visitors and a condition on a capacity of the facility, and the like can be used.

In the system according to the present invention, the first calculation basic information and the second calculation basic information may include dwell-time information for each type on a period of time during which people stay in a day, and the arithmetic means may calculate population mobility potential that is an index value of potential population mobility, from the estimate value of the number of visitors for each of the time zones sectioning the predetermined period of time and the dwell-time information.

### BRIEF DESCRIPTION OF DRAWINGS

FIG. 1 A block diagram showing a structure of a population mobility estimation system according to an embodiment of the present invention.

FIG. 2 A diagram for explaining steady mobility facilities and variable mobility facilities.

FIG. 3 A diagram showing an example of calculation masters stored in a calculation master storage unit shown in FIG. 1.

FIG. 4 Diagrams each showing an example of a daily variation pattern.

FIG. 5 Diagrams each showing another example of a daily variation pattern.

FIG. 6 Diagrams each showing an example of an annual variation pattern.

FIG. 7 A diagram for explaining a method of prorating the number of visitors based on variation pattern information.

FIG. 8 Diagrams showing a calculation example of population mobility estimation data.

FIG. 9 A diagram for explaining estimation of population mobility in a floor unit according to another embodiment of the present invention.

FIG. 10 A diagram for explaining a method of calculating total population, average population, population mobility potential on hourly, daily, and monthly basis according to another embodiment of the present invention.

FIG. 11 A diagram showing a method of calculating total population on hourly, daily, and monthly basis in the calculation method shown in FIG. 10.

FIG. 12 A diagram showing a method of calculating average population on hourly, daily, and monthly basis in the calculation method shown in FIG. 10.

### BEST MODES FOR CARRYING OUT THE INVENTION

Hereinafter, description will be given of a population mobility estimation system according to an embodiment of the present invention with reference to the drawings.

The population mobility estimation system is constituted of hardware of a typical computer system. In other words, the computer system includes, as hardware, for example, a CPU (Central Processing Unit), a RAM (Random Access Memory) as a main memory, a storage apparatus for data, programs, and the like, a keyboard and a display apparatus as user interfaces, and a network connection unit that processes communication connection to a network such as the Internet, and further includes data-readable/writable media interfaces with respect to detachable media, and the like. As the detachable media, an optical disc, a magnetic disk, a semiconductor memory, and other media in various forms are conceivable.

In the storage apparatus, programs and various types of data for causing the computer system to function as the population mobility estimation system are stored. The programs and various types of data stored in the storage apparatus are loaded into the RAM serving as a main memory to be used as a target of arithmetic processing. The programs are loaded into the RAM serving as a main memory to cause the computer system to function as the population mobility estimation system.

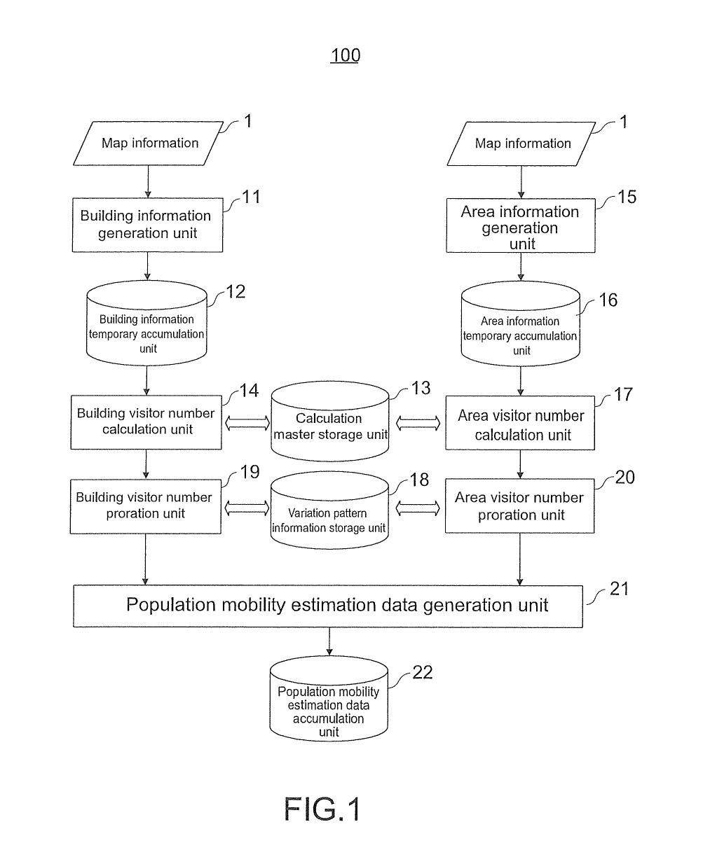

FIG. 1 is a block diagram showing a structure of a population mobility estimation system 100 according to this embodiment, which is structured using the computer system described above.

As shown in the figure, the population mobility estimation system 100 includes a building information generation unit 11, a building information temporary accumulation unit 12, a calculation master storage unit 13 (calculation basic information storage unit), a building visitor number calculation unit 14 (arithmetic means), an area information generation unit 15, an area information temporary accumulation unit 16, an area visitor number calculation unit 17 (arithmetic means), a variation pattern information storage unit 18, a building visitor number proration unit 19, an area visitor number proration unit 20, a population mobility estimation data generation unit 21, and a population mobility estimation data accumulation unit 22.

The building information generation unit 11 generates building information from map information 1. Here, “map information” is general-purpose electronic data including detailed information on facilities that appear on a map, and the like. “Facilities” is a generic name of “building”, “area”, and the like where people come in and out. The detailed information on facilities includes at least “facility name”, “position information (latitude and longitude)”, and the like and may include “address”, “floor number”, “surface area”, and the like in some cases.

“Facilities” is broadly classified into “building” and “area”. “Building” means only buildings as facilities, and “area” means not only buildings but also sites as facilities. To generate building information, the building information generation unit 11 extracts, from the map information 1, detailed information on a facility that belongs to “building” and estimates a building type on the basis of, for example, “facility name” included in the extracted detailed information. Further, in the case where the detailed information in the map information 1 includes more detailed information such as “floor number”, “surface area”, and the like of the building, the building information generation unit 11 determines “total floor area” of the building on the basis of those information items such as “floor number”, “surface area”, and the like.

Further, the building information generation unit 11 associates “type” and “total floor area” of the building with the detailed information on the facility and accumulates the associated information in the building information temporary accumulation unit 12 as “building information”. Further, in the case where the detailed information on a facility does not include more detailed information such as “floor number”, “surface area”, and the like, the building information generation unit 11 estimates a surface area of the building from image information of the map and performs multiplication with an average value corresponding to the type of a facility to thereby estimate “total floor area”.

The calculation master storage unit 13 stores calculation masters as calculation basic information required to estimate an annual visitor number for each facility. The calculation masters are each defined for a type of a facility.

The building visitor number calculation unit 14 calculates estimate values of a daily number and an annual number of visitors to the building from the building information accumulated in the building information temporary accumulation unit 12 and the calculation master stored in the calculation master storage unit 13.

The area information generation unit 15 generates area information from the general-purpose map information 1. In other words, the area information generation unit 15 extracts, from the map information 1, detailed information on a facility that belongs to “area” and estimates an area type on the basis of, for example, “facility name” included in the extracted detailed information. Then, the area information generation unit 15 associates the estimated area type with the detailed information on the facility and accumulates the associated information in the area information temporary accumulation unit 16 as “area information”.

The area visitor number calculation unit 17 calculates estimate values of a daily number and an annual number of visitors to the area from the area information accumulated in the area information temporary accumulation unit 16 and “calculation master” stored in the calculation master storage unit 13.

The variation pattern information storage unit 18 stores an hourly correction coefficient as information on a variation pattern indicating a temporal variation tendency of population mobility for each facility type.

The building visitor number proration unit 19 performs processing of prorating the number of visitors to the building, which is calculated by the calculation unit 14, on hourly, daily, and monthly basis, for example, using an hourly correction coefficient that corresponds to an appropriate building type and is stored in the variation pattern information storage unit 18.

The area visitor number proration unit 20 performs processing of prorating the number of visitors to the area, which is calculated by the area visitor number calculation unit 17, on hourly, daily, and monthly basis, for example, using an hourly correction coefficient that corresponds to an appropriate area type and is stored in the variation pattern information storage unit 18.

The population mobility estimation data generation unit 21 generates population mobility estimation data for each regional unit of a predetermined surface area, using a calculation result of the building visitor number proration unit 19 and that of the area visitor number proration unit 20.

The population mobility estimation data accumulation unit 22 accumulates the population mobility estimation data generated by the population mobility estimation data generation unit 21.

[Classification of Facilities]

As described above, facilities are broadly classified into “building” and “area”. “Building” is, for example, “housing”, “collective housing”, “firm”, or “supermarket”, which means only buildings as facilities. As a matter of course, types of facilities that belong to “building” are not limited to the above. “Area” is, for example, “farm”, “theme park”, “tourist spot and resort”, or “bathing beach”, which means not only buildings but also sites as facilities. As a matter of course, types of facilities that belong to “area” are not limited to the above.

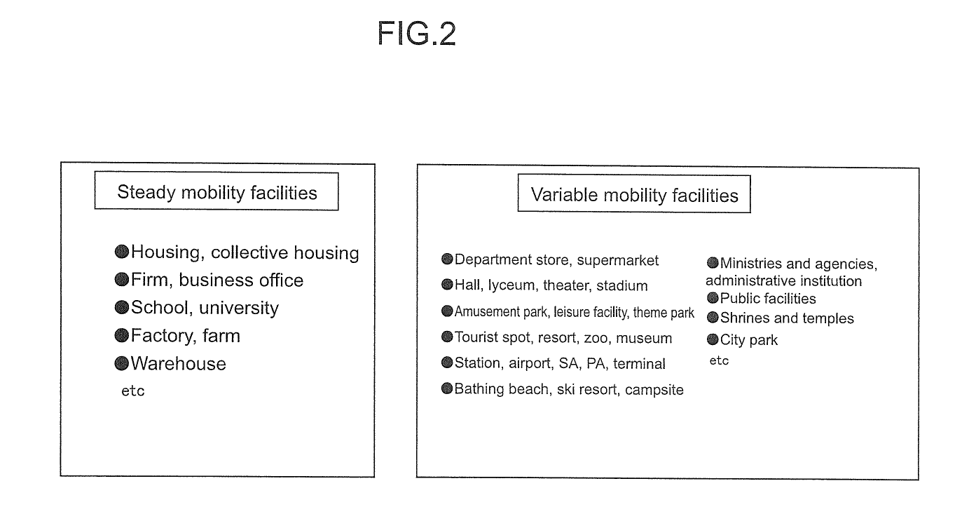

Further, separately from the classification of “building” and “area”, facilities are classified into “steady mobility facilities” and “variable mobility facilities” as shown in FIG. 2, for example, based on a difference in the way population moves. “Steady mobility facilities” means facilities where specific people mainly come in and out routinely. For example, among the above-mentioned examples of facilities, “housing”, “collective housing”, “farm”, and the like apply to this. “Variable mobility facilities” means facilities where unspecified people come in and out in a fluid manner. For example, among the above-mentioned examples of facilities, “supermarket”, “theme park”, “tourist spot and resort”, “bathing beach”, and the like apply to this.

[Detail of Calculation Master]

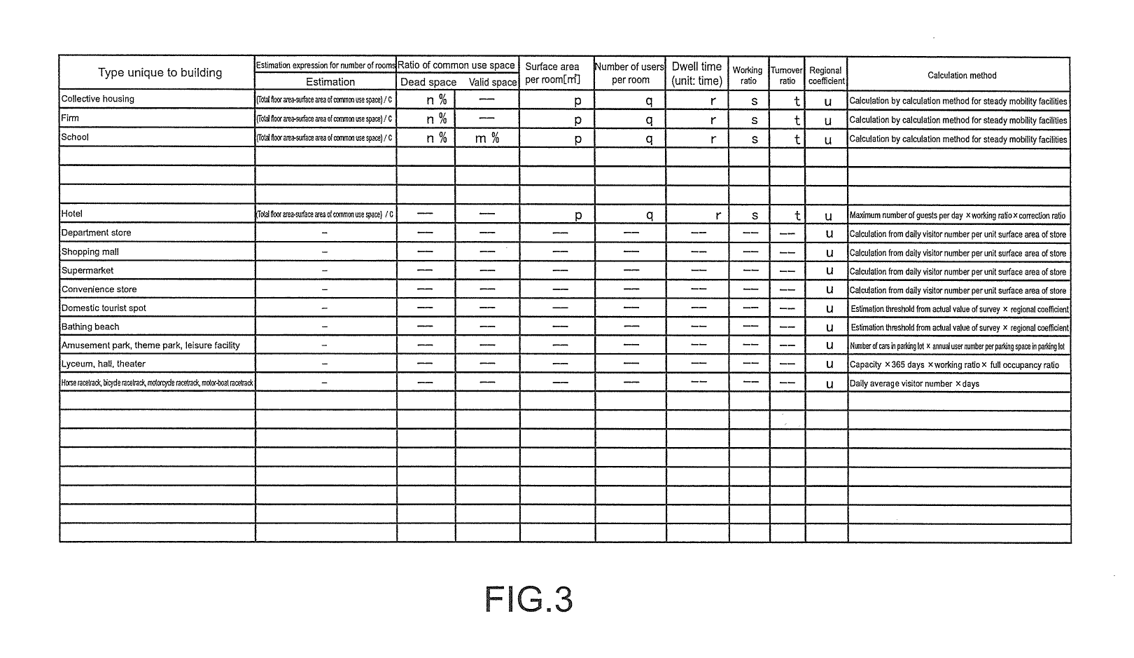

FIG. 3 is a diagram showing an example of calculation masters stored in the calculation master storage unit 13. Each of the calculation masters is calculation reference information used for estimating an annual number of visitors for each facility. The calculation masters have different preparation guidelines for a calculation master (first calculation basic information) of the steady mobility facilities and a calculation master (second calculation basic information) of the variable mobility facilities.

The calculation master of the steady mobility facilities will first be described.

The calculation master of the steady mobility facilities includes “estimation expression for number of rooms”, “ratio of common use space”, “surface area (unit surface area) per room”, “number of users per room”, “dwell time”, “working ratio”, “turnover ratio”, “regional dimension coefficient”, “calculation method”, and the like.

“Estimation expression for number of rooms” is an expression for estimating the number of rooms in one building. “Estimation expression for number of rooms” is given by a calculation expression of (total floor area−surface area of common use space)/C in the case of a “building” that belongs to the steady mobility facilities. C represents a surface area per room. In the calculation master, all types of “estimation expressions for number of rooms” that belong to the steady mobility facilities are common herein. Alternatively, estimation expressions corresponding to the types may be adopted.

“Ratio of common use space” is a ratio of a common use space (for example, entrance, corridor, stairs, elevator, and the like) occupying “total floor area”.

“Dwell time” is a period of time during which a person stays in the building in a usual day.

“Working ratio” is a value indicating an annual valid rate with respect to a value of a dwell time and is, for example, a value determined in consideration of the number of days off, the number of days of absence, and the like.

“Turnover ratio” is a value of the number of times those who stay exchange in a day.

“Regional dimension coefficient” is a coefficient given in accordance with regional characteristics such as a land price for each region, a use form of a land, and a population density.

“Calculation method” is a detailed calculation method for an annual number of visitors (an annual number of resident people). In the case of a facility that belongs to the steady mobility facilities, a predetermined calculation expression using values of respective items other than “calculation method” defined by the calculation master is commonly defined for almost all the types belonging to the steady mobility facilities. In other words, adjustment necessary for each building type is performed by adjustment of the values of the respective items other than “calculation method” on the calculation master.

The above-mentioned values of the respective items registered in the calculation master of the steady mobility facilities are statistically determined on the basis of, for example, inhabitant population (mainly in nighttime) based on a population census, employee and student population (mainly in daytime), legal standard data (design standard, disaster prevention standard, installation standard, etc.), and the like.

Next, the calculation master of the variable mobility facilities will be described.

The calculation master for facilities that belong to the variable mobility facilities is determined in accordance with a type of that facility as follows.

For example, for the calculation master of “shopping mall”, “supermarket”, “department store”, “convenience store”, and the like, a calculation method of “calculation based on daily number of visitors per unit surface area of store” is defined. The “daily number of visitors per unit surface area of store” defines a daily number of visitors per unit surface area of a store on a regional basis, based on “average number of visitors on regional basis” surveyed and released in advance.

For the calculation master of “hotel”, a calculation method of “calculation by multiplying maximum number of guests per day by working ratio and correction ratio” is defined. The same holds true for a calculation master of “inn” and “other accommodations” similar to “hotel”. “Maximum number of guests per day” is a value calculated from a total floor area or the number of guest rooms. “Working ratio” is a coefficient that is uniquely determined in advance in accordance with a facility type. “Correction ratio” is a coefficient determined in accordance with regional characteristics such as a regional population density, similar to “regional dimension coefficient”.

For the calculation master of “amusement park”, “theme park”, “leisure facility”, and the like, a calculation method of “number of cars in parking lot×annual number of users per parking space in parking lot” is defined. For the calculation master of “lyceum”, “hall”, and “theater”, a calculation method of “capacity×365 days×working ratio×full occupancy ratio” is defined. Here, for information on “number of cars in parking lot”, “annual number of users per parking space in parking lot”, “capacity”, “working ratio”, “full occupancy ratio”, and the like, it is effective to adopt information obtained from publication data of the Web, a book, and the like or information obtained by a field research and the like in terms of improvement in estimation accuracy. In the case where unique values of those facilities do not exist, values statistically obtained are adopted so that minimal accuracy is ensured.

The above-mentioned “calculation method” of the calculation master of the variable mobility facilities is created based on an actual survey value for each type, for example, as follows. While a real number of visitors is counted for each facility type, an index having a correlation with the real number of visitors for each facility type, for example, the number of cars in a parking lot and the like are counted. A correlation between the real number of visitors and the index value is determined, and in addition, a correction by regional characteristics such as a regional population density is added to the correlation. Accordingly, a calculation master by a correlation between the real number of visitors and the index value is obtained. For example, the calculation master of “amusement park”, “theme park”, and “leisure facility” is created based on the correlation between the real number of visitors and the index value (number of cars in parking lot) as described above.

Further, for a facility with a fixed capacity, for example, each of facilities such as “hotel”, “lyceum”, “hall”, “theater”, “gymnasium”, “baseball field”, “football ground”, and “stadium”, a calculation expression based on a capacity is defined as “calculation method”. In this case, a calculation expression may be an expression obtained in consideration with information such as a working ratio uniquely determined in accordance with the type, the number of operating days obtained from publication data, and the like.

[Calculation of Number of Visitors to Building]

Next, a calculation procedure for the number of visitors to a building will be described.

First, the building information generation unit 11 extracts detailed information on a facility from the map information 1, the detailed information including “facility name”, “position information (latitude and longitude)”, and the like, and accumulates the information as building information in the building information temporary accumulation unit 12.

The building visitor number calculation unit 14 takes out “facility name” included in the detailed information on the facility from the building information temporary accumulation unit 12, checks this “facility name” against a facility type-keyword correspondence table defined in advance, and determines a type of the facility. The facility type-keyword correspondence table is a table in which keywords highly likely used in names are registered for each facility type. Therefore, in the case where the facility name is “ox office building”, owing to the keyword “office” in the facility name, the facility type is determined to be “firm”.

After determining the facility type, the building visitor number calculation unit 14 refers to a calculation master for that type from the calculation master storage unit 13. Next, the building visitor number calculation unit 14 reads “calculation method” defined in the calculation master and calculates an estimate value of an annual number of visitors to the facility according to this “calculation method”.

For example, in the case where the type of the facility applies to the steady mobility facilities such as “firm”, the building visitor number calculation unit 14 first estimates a total floor area of this steady mobility facility according to the “calculation method” defined in the calculation master corresponding to the type of the steady mobility facility, and calculates, from the total floor area, an estimate value of the number of rooms according to “estimation expression for number of rooms=(“total floor area”−surface area of common use space)/surface area per room” of the calculation master. Then, from the information on the estimate value of the number of rooms and “number of users per room”, “working ratio”, “turnover ratio”, and “regional dimension coefficient” of the calculation master, the building visitor number calculation unit 14 calculates a daily number of resident people of the steady mobility facility as “daily number of visitors”, and multiplies this calculation result by “number of operating days” to obtain an annual number of resident people as “annual number of visitors”. For other types of steady mobility facilities, an annual number of resident people can also be obtained similarly as “annual number of visitors”.

Further, in the case where a facility determined based on “facility name” is a variable mobility facility such as “supermarket”, the building visitor number calculation unit 14 calculates an estimate value of an annual number of visitors to the variable mobility facility according to “calculation method” defined by the calculation master for this variable mobility facility, for example, as follows.

As an example, a case where a variable mobility facility is “supermarket” will be described. In the calculation master for “supermarket”, a calculation method of “calculation based on daily number of visitors per unit surface area of store” is defined. In this regard, according to the definition of the calculation method, the building visitor number calculation unit 14 first estimates “total floor area” of this variable mobility facility, calculates a daily number of visitors to this supermarket from the total floor area and the daily number of visitors per unit surface area of store, and multiplies this calculation result by “365” to obtain an annual number of visitors. For other types of variable mobility facilities, an annual number of visitors can also be obtained similarly according to “calculation method” defined in the calculation master corresponding to a type thereof.

[Details of Variation Pattern Information]

A daily variation in population mobility of steady mobility facilities is largely different in pattern between housing such as “collective housing” and facilities belonging to the steady mobility facilities other than housing. Further, a pattern of a daily variation in population mobility of the variable mobility facilities has a feature corresponding to a facility type.

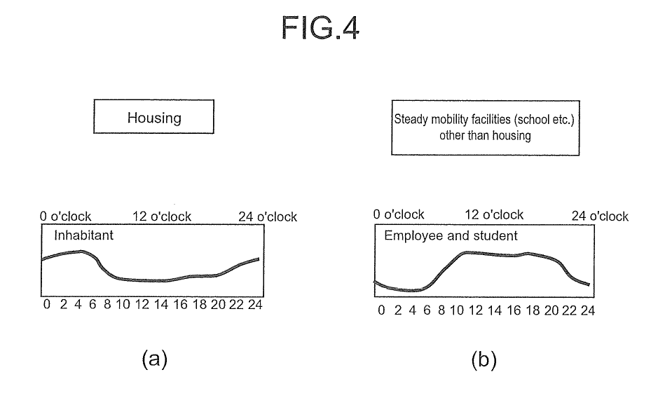

FIG. 4(a) is a diagram showing a variation pattern in population mobility of housing in a day (24 hours). FIG. 4(b) is a diagram showing a variation pattern of the steady mobility facilities other than housing. As shown in the figures, those two variation patterns have a mutually complementary relationship. In other words, during the nighttime, the population mobility of housing increases, and the population mobility of the steady mobility facilities other than housing decreases, and during the daytime, they are reversed.

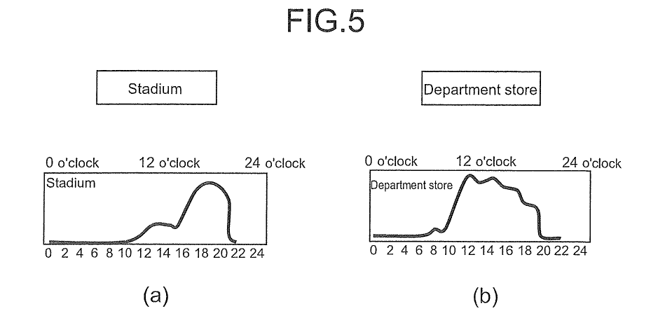

FIG. 5(a) is a diagram showing a variation pattern in population mobility of “stadium” belonging to the variable mobility facilities in a day (24 hours). FIG. 5(b) is a diagram showing a variation pattern of “department store” similarly belonging to the variable mobility facilities. In “stadium”, the population mobility generally increases between the hours from about 12 o'clock to about 22 o'clock, and a peak is present particularly between the hours from about 18 o'clock to about 20 o'clock, but the population significantly decreases in other time zones. On the other hand, in “department store”, the population rapidly increases from an opening time and reaches a peak at about 12 o'clock, and thereafter the population gradually decreases until a closing time while repeating slight increase or decrease. This variation pattern of “department store” is commonly found in other “commercial facilities”.

Next, an annual variation pattern of population mobility will be described.

The annual variation of population mobility shows an outstanding feature particularly in “outdoor leisure”, “tourist spot and resort”, and the like.

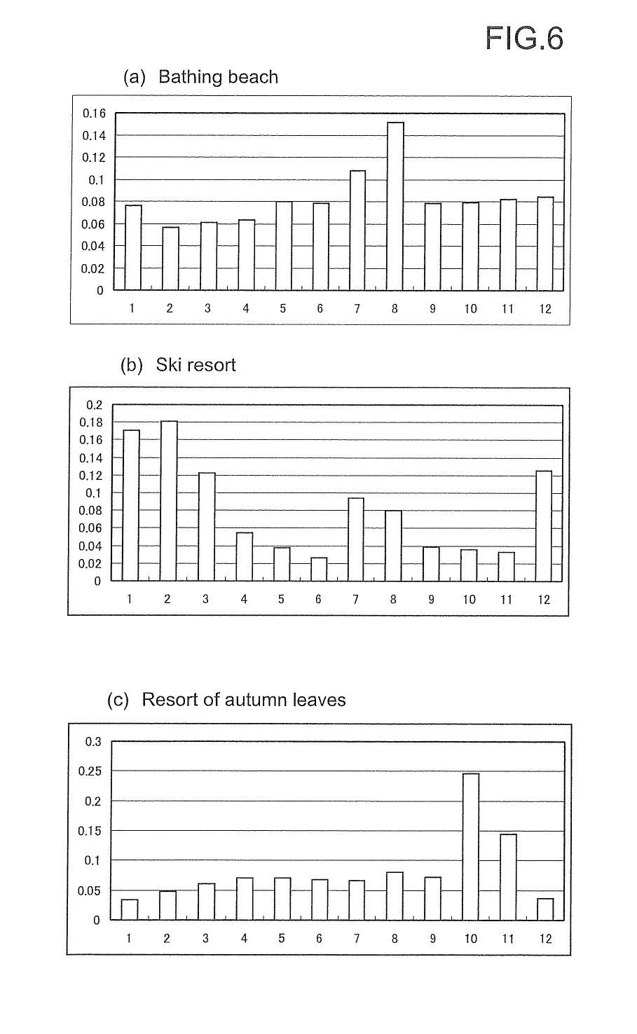

FIG. 6(a) is a diagram showing an example of an annual variation pattern of population mobility of “bathing beach”, FIG. 6(b) is a diagram showing an example of that of “ski resort”, and FIG. 6(c) is a diagram showing an example of that of “resort” of autumn leaves. As shown in the figures, depending on types of facilities, months and seasons in which population increases are determined. In other words, a population peak of “bathing beach” is in summer, that of “ski resort” is in winter, and that of “resort” of autumn leaves is in autumn. In addition, though not shown in the figures, features corresponding to the types of facilities are also present in daily variations.

As described above, the variation pattern information storage unit 18 stores an hourly correction coefficient as pattern information indicating a temporal variation tendency of population mobility for each facility type. For example, in the case of the annual variation, the hourly correction coefficient is given as a value indicating a ratio for prorating an annual number of visitors by months from January to December.

[Details of Processing by Building Visitor Number Proration Unit 19]

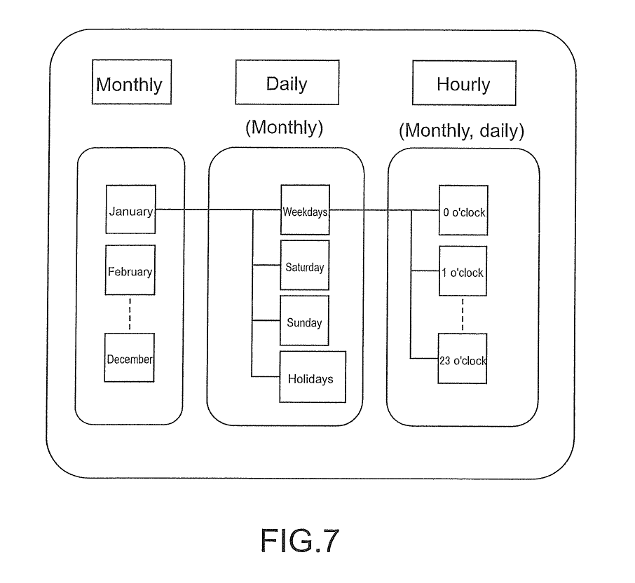

The building visitor number proration unit 19 prorates the number of visitors to a building, which is calculated by the building visitor number calculation unit 14, on hourly, daily, and monthly basis for example, based on the hourly correction coefficient as variation pattern information that corresponds to an appropriate type of the building and is stored in the variation pattern information storage unit 18, and calculates total population and average population for each time unit. Accordingly, as shown in FIG. 7, total population and average population having hierarchical relationships on hourly, daily, and monthly basis are obtained.

[Details of Processing by Area Visitor Number Proration Unit 20]

Processing by the area visitor number proration unit 20 is basically the same as the processing by the building visitor number proration unit 19. In other words, the area visitor number proration unit 20 prorates the number of visitors to an area, which is calculated by the area visitor number calculation unit 17, on hourly, daily, and monthly basis, for example, based on the hourly correction coefficient that corresponds to an appropriate type of the area and is stored in the variation pattern information storage unit 18, and calculates total population and average population for each time unit.

[Details of Processing by Population Mobility Estimation Data Generation Unit 21]

The population mobility estimation data generation unit 21 combines calculation results for each time unit obtained by the building visitor number proration unit 19 and calculation results for each time unit obtained by the area visitor number proration unit 20 with each other, to generate population mobility estimation data of each region with a predetermined surface area for each time unit. As the region with a predetermined surface area, a region obtained by sectioning a map by latitude and longitude units of 500 m×500 m is adopted in this embodiment. In other words, for facilities that are present in the region of 500 m×500 m, a combination of the calculation results for each time unit obtained by the building visitor number proration unit 19 and those for each time unit obtained by the area visitor number proration unit 20 is obtained as population mobility estimation data.

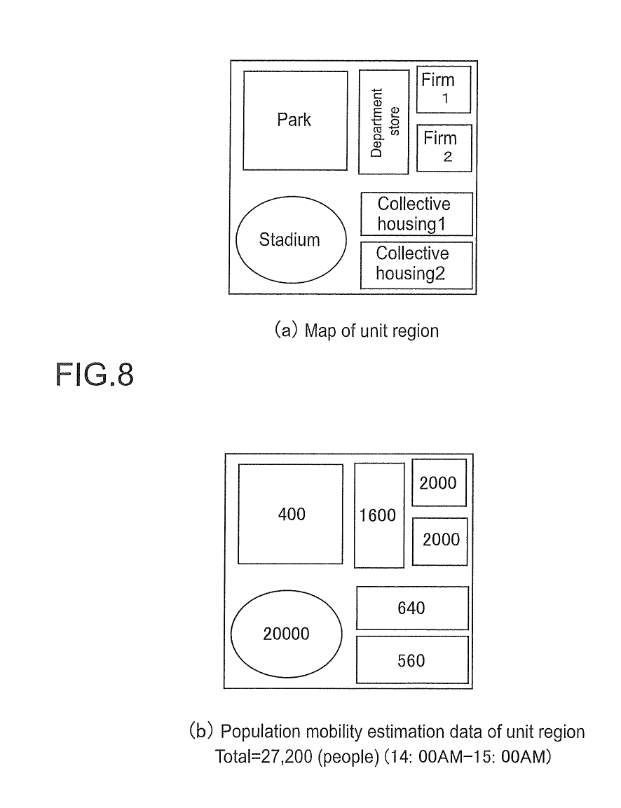

FIG. 8 are diagrams showing a calculation example of the population mobility estimation data.

FIG. 8(a) shows a concept of a map of one unit region of 500 m×500 m, and FIG. 8(b) shows calculation results of population mobility in a certain time zone (14:00 a.m. to 15:00 a.m.). As shown in FIG. 8(a), it is assumed that a park, a department store, a firm 1, a firm 2, collective housing 1, collective housing 2, and a stadium are present in the unit region. As a result of calculation by the population mobility estimation data generation unit 21, as shown in FIG. 8(b), population mobility in a time zone from 14:00 a.m. to 15:00 a.m. is calculated as follows, for example: park=400(people), department store=1,600(people), firm 1=2,000(people), firm 2=2,000(people), collective housing 1=640(people), collective housing 2=560(people), and stadium=20,000(people). Therefore, the population mobility in the time zone from 14:00 a.m. to 15:00 a.m. in the unit region of 500 m×500 m is estimated to be 27,200 (people). Similarly, population mobility in a daily or monthly unit can be estimated.

The population mobility estimation data generated by the population mobility estimation data generation unit 21 as described above is accumulated in the population mobility estimation data accumulation unit 22. In this case, the population mobility estimation data generation unit 21 imparts index information including identification information such as a latitude/longitude and an address to the population mobility estimation data of the unit region of 500 m×500 m, and the resultant is accumulated in the population mobility estimation data accumulation unit 22. Accordingly, using a latitude/longitude, an address, and the like as search keys, population mobility estimation data of a target location can be uniquely retrieved. Results of retrieval can be output to, for example, a display apparatus, a printing apparatus, and the like as visual information. Examples of an output format of the visual information include a text format and a graph (two-dimensional graph or three-dimensional graph) format.

It should be noted that in this embodiment, population mobility estimation data is generated in a unit of the region of 500 m×500 m, but a size of the unit region may be arbitrarily set by a user.

Further, population mobility estimation data in each unit region of 500 m×500 m may further be combined to generate population mobility estimation data in a unit of a larger region.

It should be noted that depending on a region and a season as in fireworks, festivals, and New Year's visit to shrines, population mobility may rapidly increase. Therefore, population mobility thereof is also surveyed in advance from publication data of past records and the like to be used for estimation of population mobility.

Further, correction based on a regional dimension coefficient may be used in correction for population mobility in a unit region of 500 m×500 m.

According to this embodiment described above, population mobility can be estimated in consideration of a facility type. In other words, by classifying facilities into “steady mobility facilities” and “variable mobility facilities” and defining calculation masters including calculation methods corresponding to respective characteristics to estimate population mobility, population mobility in which a facility type is taken into consideration can be estimated with relatively good accuracy. In particular, by defining a calculation master including a calculation method defined based on an actual survey value for each type of a facility that belongs to the variable mobility facilities, as a calculation method for population mobility of a facility that belongs to “variable mobility facilities”, population mobility of a facility that belongs to the variable mobility facilities can be additionally improved in estimation accuracy. Further, according to this embodiment, by temporal variation pattern information corresponding to a facility type, population mobility on a time zone basis such as on hourly, daily, and monthly basis can be estimated.

### MODIFIED EXAMPLE

Regarding the calculation by the building visitor number calculation unit 14 and the area visitor number calculation unit 17, in the case where annual visitors to a specific facility (building, area) and the like are known in advance by a survey, a name of the specific facility and survey data of the annual visitors are associated with each other to be stored in the calculation master storage unit 13 as unique information. In particular, in the case where the scale of the facility is large, since annual visitors are easily known from the Web, a book, and the like, this method is effective. By retrieving appropriate unique information with “building name” extracted from building information as a key in the calculation of an annual number of visitors with use of a calculation master, the building visitor number calculation unit 14 and the area visitor number calculation unit 17 acquire survey data of annual visitors to an appropriate facility as a calculation result.

Further, after a name of a specific facility, a latitude/longitude, and survey data of annual visitors are associated with one another and stored in the calculation master storage unit 13 as unique information, the building visitor number calculation unit 14 and the area visitor number calculation unit 17 may retrieve, in the calculation of an annual number of visitors with use of a calculation master, appropriate unique information with a latitude/longitude and a building name extracted from building information as keys, to thereby acquire survey data of annual visitors to an appropriate facility as a calculation result. In this case, when different facilities with the same name exist, survey data of annual visitors can be correctly acquired while distinguishing the facilities from each other.

### Other Embodiments

[Estimation of Population Mobility in Unit of Floor]

In the embodiment described above, in the estimation of population mobility, one building is considered as one facility, and a daily number of visitors to the building, an annual number of visitors thereto, and the like are estimated using a calculation master defined in advance in accordance with this facility. However, the present invention is not limited to this.

In the case of a building with a plurality of floors, there may be a case where different facilities exist depending on floors. In such a case, the building visitor number calculation unit 14 may use a corresponding calculation master for each of the facilities different in type in one building, to estimate a daily number of visitors, an annual number of visitors, and the like of each facility. Alternatively, by combining daily numbers of visitors, annual numbers of visitors, and the like that are estimated for the respective facilities different in type in one building, a daily number of visitors, an annual number of visitors, and the like of the building may be obtained.

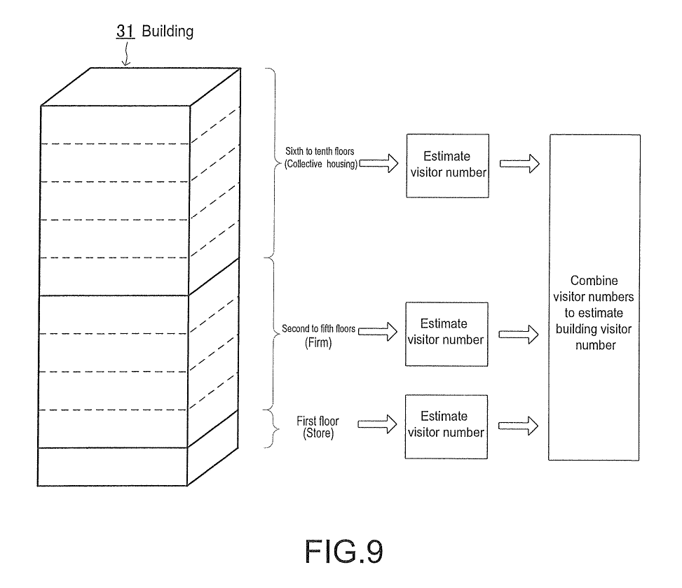

For example, FIG. 9 exemplifies a building having ten floors in which the first floor is a store such as a convenience store, the second to fifth floors are firms, and the sixth to tenth floors are collective housing. Assuming that a floor area of each floor is common, a ratio of each facility to “total floor area” of the entire building is 10% for the convenience store, 40% for the firms, and 50% for the collective housing. Therefore, if a value of the total floor area of the entire building is obtained, a gross floor area of each facility is also obtained, with the result that based on a calculation master corresponding to each facility, estimate values such as a daily number of visitors and an annual number of visitors of each facility can be obtained in the building visitor number calculation unit 14. In such a manner, compared to a system of estimating the number of visitors while considering one building as one facility, a population mobility estimate value of higher accuracy can be obtained.

[Unit in which Population Mobility Estimation Data is Generated]

In the embodiment described above, population mobility estimation data is generated in a unit of a region of, for example, 500 m×500 m, but the present invention is not limited thereto. The population mobility estimation data may be generated in various other units. Examples of other units include the following.

A. Unit of cell (unit of coverage area for each base station)

B. Unit of Voronoi region (Voronoi points are effective to be set at traffic sites (stations in Japan, stations and gas stations in the United States))

C. Address (unit of town or chome (district of town) and sectional unit of postal codes in Japan)

D. Sectional unit in SENSUS2010 (population census of Unites States)

[Calculation of population mobility estimation data (population mobility potential) in which dwell time is taken into consideration]

As described above, a dwell time is a period of time during which a person stays in a building or an area in a usual day and is information defined in advance for each type of facility on the basis of statistical data. Population mobility estimation data in which a dwell time is taken into consideration is expected to be used as population mobility potential serving as an index value of potential population mobility for various purposes such as an arrangement plan of wireless base stations by a telecommunication carrier that provides communication services for a mobile phone, for example. Hereinafter, a method of calculating the population mobility potential will be described.

As described above, from an estimate value of an annual number of visitors to a certain facility, which is calculated by the building visitor number calculation unit 14, and an hourly correction coefficient as variation pattern information on monthly, daily, and hourly basis, which corresponds to a type of the facility, the building visitor number proration unit 19 calculates total population and average population on monthly, daily, and hourly basis and calculates the population mobility potential as follows.

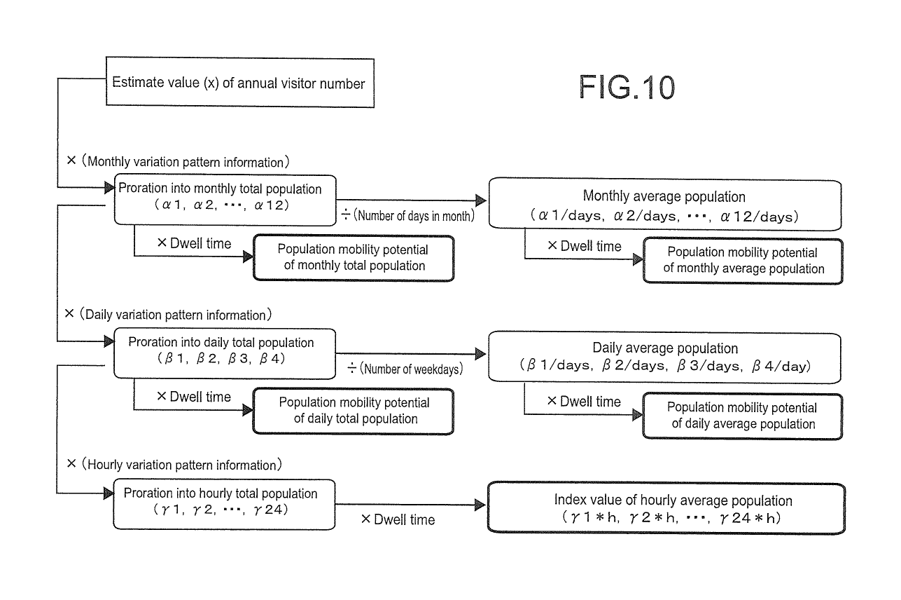

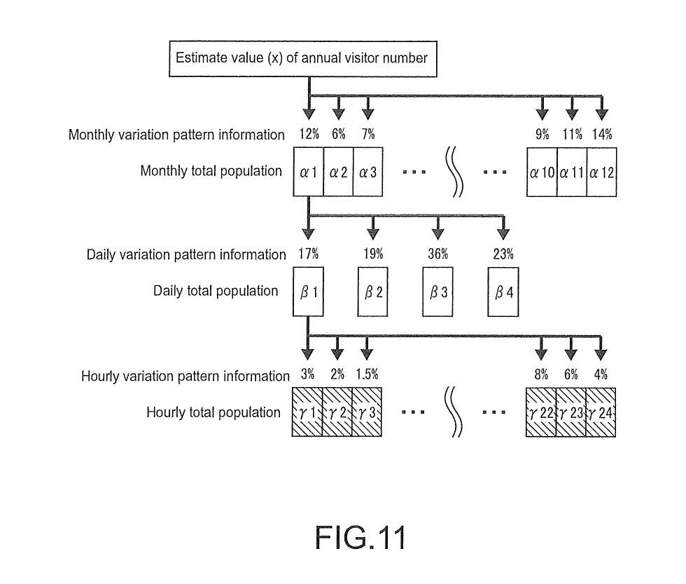

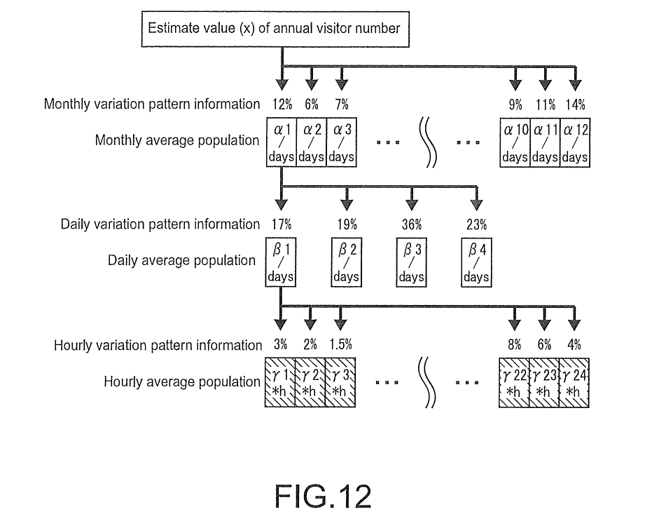

FIG. 10 is a diagram for explaining a method of calculating total population, average population, and population mobility potential on monthly, daily, and hourly basis. FIG. 11 is a diagram showing a method of calculating total population particularly on hourly, daily, and monthly basis in the calculation method shown in FIG. 10. In addition, FIG. 12 is a diagram showing a method of calculating average population on hourly, daily, and monthly basis in the calculation method shown in FIG. 10.

The building visitor number proration unit 19 first prorates an estimate value (x) of an annual number of visitors to a certain facility, which is calculated by the building visitor number calculation unit 14, into monthly total population (α1, α2, . . . , α12) based on monthly variation pattern information. Next, the building visitor number proration unit 19 prorates the monthly total population (α1, α2, . . . , α12) into daily total population (β1, β2, β3, β4) based on daily variation pattern information. Here, β1 is total population of a weekday, β2 is that of Saturday, β3 is that of Sunday, and β4 is that of a holiday. Next, the building visitor number proration unit 19 prorates the daily total population (β1, β2, β3, β4) into hourly total population (γ1, γ2, . . . , γ24) based on hourly variation pattern information.

Further, the building visitor number proration unit 19 divides the monthly total population (α1, α2, . . . , α12) by the number of days of a month corresponding thereto and obtains monthly average population (α1/days, α2/days, α12/days), that is, the number of days obtained by converting the monthly total population into population per day. In addition, the building visitor number proration unit 19 divides the daily total population (β1, β2, β3, β4) by the number of days for that day of the week per month, and obtains daily average population (β1/days, β2/days, β3/days, β4/days), that is, the number of days obtained by converting the daily total population into population per day. In addition, the building visitor number proration unit 19 obtains a result obtained by multiplying the hourly total population (γ1, γ2, . . . , γ24) by a dwell time (h) corresponding to a type of the facility, as an index value (γ1*h, γ2*h, . . . , γ24*h) of hourly average population. Accordingly, hourly population mobility in which a dwell time is taken into consideration is obtained. The building visitor number proration unit 19 further obtains a value obtained by summing the hourly population mobility for 24 hours, in which a dwell time is taken into consideration, as population mobility potential of the facility.

Further, the building visitor number proration unit 19 can obtain a result of multiplying the monthly total population (α1, α2, . . . , α12) by a dwell time (h) as population mobility potential of the monthly total population. Similarly, the building visitor number proration unit 19 can also obtain a result of multiplying the daily total population (β1, β2, β3, β4) by the dwell time (h) as population mobility potential of the daily total population. In addition, the building visitor number proration unit 19 can also obtain a result of multiplying the monthly average population (α1/days, α2/days, . . . , α12/days) by the dwell time (h) as population mobility potential of the monthly average population, and a result of multiplying the daily average population (β1/days, β2/days, β3/days, β4/days) by the dwell time (h) as population mobility potential of the daily average population.

Hereinabove, the method in which the calculating building visitor number proration unit 19 calculates the population mobility potential on the number of visitors to a building has been described. However, population mobility potential on the number of visitors to an area can also be calculated similarly in the area visitor number proration unit 20.

It should be noted that the present invention is not limited to the embodiments described above and can variously be modified without departing from the gist of the present invention.

### DESCRIPTION OF SYMBOLS

1 map information
11 building information generation unit
12 building information temporary accumulation unit
13 calculation master storage unit
14 building visitor number calculation unit
15 area information generation unit
16 area information temporary accumulation unit
17 area visitor number calculation unit
18 variation pattern information storage unit
19 building visitor number proration unit
20 area visitor number proration unit
21 population mobility estimation data generation unit
22 population mobility estimation data accumulation unit
100 population mobility estimation system

1. A population mobility estimation system, comprising:
a calculation basic information storage unit to store first calculation basic information that is required for estimating the number of visitors to steady mobility facilities within a predetermined period of time, the steady mobility facilities serving as facilities where specific people come in and out routinely, and is obtained by further classifying the steady mobility facilities by type, and second calculation basic information that is required for estimating the number of visitors to variable mobility facilities within a predetermined period of time, the variable mobility facilities serving as facilities where unspecified people come in and out in a fluid manner, and is based on an actual survey value for each type obtained by further classifying the variable mobility facilities by type; and
an arithmetic means for extracting detailed information including at least a name of one of the facilities from map information, estimating a type of the facility based on the extracted name of the facility, and referring to the first calculation basic information or the second calculation basic information that corresponds to the type from the calculation basic information storage unit based on the estimated type, to calculate an estimate value of the number of visitors to the facility within a predetermined period of time.

2. The population mobility estimation system according to claim 1, further comprising a variation pattern information storage unit to store variation pattern information for each type indicating a temporal variation tendency of the number of visitors, for each of the types of the steady mobility facilities and the variable mobility facilities, wherein
the arithmetic means calculates an estimate value of the number of visitors within a predetermined period of time, the estimate value being calculated for the facility, and an estimate value of the number of visitors for each of time zones sectioning the predetermined period of time based on variation pattern information of the facility that is stored in the variation pattern information storage unit.

3. The population mobility estimation system according to claim 2, wherein
the first calculation basic information and the second calculation basic information include a coefficient for performing correction corresponding to an area on a calculation result of the estimate values of the number of visitors within the predetermined period of time.

4. The population mobility estimation system according to claim 3, wherein
the second calculation basic information of at least a part of types of facilities that belong to the variable mobility facilities is a calculation expression defined by a correlation between an actual survey value of a real number of visitors and the number of cars in a parking lot.

5. The population mobility estimation system according to claim 3, wherein
the second calculation basic information of at least a part of types of facilities that belong to the variable mobility facilities is a predetermined value based on an actual survey value of the number of visitors within a predetermined period of time.

6. The population mobility estimation system according to claim 3, wherein
the second calculation basic information of at least a part of types of facilities that belong to the variable mobility facilities is a calculation expression defined by a correlation between an actual survey value of a real number of visitors and a condition on a capacity of the facility.

7. The population mobility estimation system according to claim 3, wherein
the arithmetic means combines estimate values of the number of visitors for each of the time zones sectioning the predetermined period of time in a predetermined regional unit, the estimate values being calculated for each of the facilities, to calculate population mobility estimation data.

8. The population mobility estimation system according to claim 2, wherein
the first calculation basic information and the second calculation basic information include dwell-time information for each type on a period of time during which people stay in a day, and
the arithmetic means calculates population mobility potential that is an index value of potential population mobility, from the estimate value of the number of visitors for each of the time zones sectioning the predetermined period of time and the dwell-time information.

9. A population mobility estimation method, comprising:
storing, by a calculation basic information storage unit, first calculation basic information that is required for estimating the number of visitors to steady mobility facilities within a predetermined period of time, the steady mobility facilities serving as facilities where specific people come in and out routinely, and is obtained by further classifying the steady mobility facilities by type, and second calculation basic information that is required for estimating the number of visitors to variable mobility facilities within a predetermined period of time, the variable mobility facilities serving as facilities where unspecified people come in and out in a fluid manner, and is based on an actual survey value for each type obtained by further classifying the variable mobility facilities by type; and
extracting, by an arithmetic means, detailed information including at least a name of one of the facilities from map information, estimating a type of the facility based on the extracted name of the facility, and referring to the first calculation basic information or the second calculation basic information that corresponds to the type from the calculation basic information storage unit based on the estimated type, to calculate an estimate value of the number of visitors to the facility within a predetermined period of time.

10. A population mobility estimation program causing a computer to function as:
a calculation basic information storage unit to store first calculation basic information that is required for estimating the number of visitors to steady mobility facilities within a predetermined period of time, the steady mobility facilities serving as facilities where specific people come in and out routinely, and is obtained by further classifying the steady mobility facilities by type, and second calculation basic information that is required for estimating the number of visitors to variable mobility facilities within a predetermined period of time, the variable mobility facilities serving as facilities where unspecified people come in and out in a fluid manner, and is based on an actual survey value for each type obtained by further classifying the variable mobility facilities by type; and
an arithmetic means for extracting detailed information including at least a name of one of the facilities from map information, estimating a type of the facility based on the extracted name of the facility, and referring to the first calculation basic information or the second calculation basic information that corresponds to the type from the calculation basic information storage unit based on the estimated type, to calculate an estimate value of the number of visitors to the facility within a predetermined period of time.
